(19) United States
(12) Patent Application Publication
(10) Pub. No.: US 2003/0090512 A1
(43) Pub. Date: May 15, 2003

(54) Enhanced user interface for a remote terminal

(76) Inventors: Todres Yampel, Brooklyn, NY (US); Gad Janay, Boca Raton, FL (US)

Correspondence Address: KAPLAN & GILMAN , L.L.P., 900NROUTE 9 NORTH, WOODBRIDGE, NJ, 07095, US

(21) Appl. No.: 09/992,773

(22) Filed: Nov. 14, 2001

(51) Int. Cl. G09G 5/00

(52) U.S. Cl. 345/740; 345/744

(57) ABSTRACT

An enhanced user interface for a remote terminal is described. A terminal emulator program divides screens received at a local terminal into objects. The program monitors the objects affected by data inputs by the user. Upon receiving new screens of information from the host computer, the program compares and repaints only the affected objects, rather than the entire screen. In another technique, upon receiving signals from a pointing device to cause cursor movements, the program calculates the optimal keystrokes or combination of keystrokes required. It then simulates those keystrokes to accomplish the desired movement on the screen. Both techniques meet a demand for savings in processing bandwidth.

### TECHNICAL FIELD

This invention relates to computer networks, and more particularly, to an improved user interface preferably for use in connection with a personal computer (e.g., local terminal) or the like while connected to a remote computer.

### BACKGROUND OF THE INVENTION

Remote terminals have been in widespread use for many years. Recently, with the move towards distributed computing, it has been more and more common to utilize a host computer, often a large mainframe computer, from a local terminal by accessing the host computer over a data network. The terminal, in many cases, is actually a personal computer (“PC”) which is programmed in such a manner as to communicate with the host computer. Often, the PC is programmed to emulate a terminal so that the host computer cannot distinguish it from a simple “dumb” terminal.

One issue to be addressed by a designer of such systems is the relatively high data processing rates required to update the screen information downloaded from the host computer. In prior art systems, the programming to emulate a “dumb” terminal (the “terminal emulator”) accomplished such updates by comparing the old screen with the new screen downloaded from the host computer.

The terminal emulator would then “repaint” the PC display, using defined display parameters. Most prior art systems use an industry termed “text-to-graphics conversion”, in which screens of textual data downloaded from the host computer are reformatted into information suitable for display as part of a graphical user interface (“GUI”). The GUI is much more user friendly and provides additional functionality as compared to screens of textual data. In addition, the GUI may be customized as the user desires.

However, the above described comparison of the old screen with the new screen still requires significant bandwidth. Remote terminals that require character-based screen updating, for example, require information to be transmitted to the host computer upon each and every data entry by the user. Therefore, each data entry requires the transmission of such data, transmission from the host of the newly changed screen of information, comparison of the old and new screen information by the terminal emulator, and the repainting of the PC display.

For example, if the user were entering a name in a “name” field, the above updating steps must occur for each character in the name that is entered. Such frequent updating consumes significant processing power.

Another drawback of prior art systems is the high processing speeds required in using a mouse, a standard pointing device, in connection with a terminal emulator having a GUI display. The mouse inputs signals to move the cursor position among various fields in the display. Each time that the user clicks the mouse to cause a move on the screen, the terminal emulator program calculates the combination of keystrokes required to simulate such a move. The program then transmits each of those keystrokes to the host computer and downloads new screens of information in order to accomplish the movement on the screen. However, these calculations, transmissions, simulations, and displays again require significant processing power to accomplish. It is desirable to minimize the bandwidth required by the use of a pointing device in a terminal emulator program.

In view of the above, it can be appreciated that there exists a need in the prior art for better techniques in terminal emulation to save on processing bandwidth requirements, while maintaining or improving on its advantages and user-friendly features.

### SUMMARY OF THE INVENTION

The above and other problems of the prior art are overcome in accordance with the present invention which relates to a terminal emulator that more efficiently accomplishes screen updates, as well as more efficiently accomplishing cursor movement with a pointing device, such as a mouse.

In accordance with the invention, the emulator divides the screens transmitted from the host computer into a plurality of objects, and monitors which objects have been affected by a newly input character. When the PC receives an updated screen, the emulator program compares only the object or objects affected by the newly input character, rather than comparing the entire screen. Then, the emulator repaints only the changed portion, or object, on the PC display. This improvement saves on bandwidth, since only portions of the painted screen, rather than the entire screen, need to be compared and regenerated.

Another technical advance achieved in accordance with the present invention relates to a method of using a pointing device, in connection with a terminal emulator, that requires less processing power. Depending on where the user clicks the mouse, the emulator calculates the most efficient combination of keyboard strokes required to simulate the cursor movement. The emulator then transmits the keystroke information to the remote computer and receives updated screen information back, thereby enabling it to display the appropriate cursor movement to the user.

The terminal emulator may calculate a keystroke combination that minimizes the required number of keystrokes to move the cursor from one point to another on the display. It may, for example, use a maximum number of “tab” steps, and then a few “backspace” steps, in order to simulate the cursor movement. This minimizing of keystrokes cuts down the required date processing rate, since fewer transmissions of keystroke and screen information are required.

In summary, by dividing the screens into various objects and comparing and repainting only the changed objects in the display, and by programming the emulator to calculate the most efficient steps to move the cursor, data processing rate requirements are reduced.

### BRIEF DESCRIPTION OF THE DRAWINGS

For a fuller understanding of the invention, reference is made to the following description taken in connection with the accompanying drawings, in which:

FIG. 1 is a depiction of a small portion of an exemplary computer network;

FIG. 2 shows a flow chart of the steps to be implemented by a local terminal, in order to practice an exemplary screen updating embodiment of the subject invention;

FIG. 3 shows an exemplary screen layout;

FIG. 4 shows an exemplary screen layout divided into the object elements of the subject invention;

FIG. 5 depicts a pointing device cursor movement, more fully described later herein; and

FIG. 6 shows a flow chart of the steps to be implemented by a local terminal, in order to practice the cursor movements of the subject invention.

### DETAILED DESCRIPTION OF THE PREFERRED EMBODIMENT

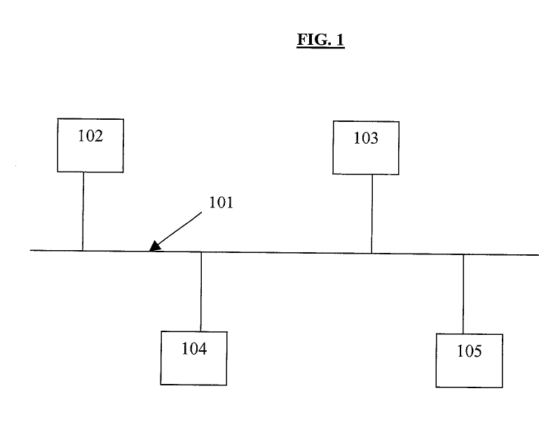

FIG. 1 shows a local area network 101 with a plurality of computers 102 through 105 connected thereto. The network 101 may be, for example, an Ethernet, or any other suitable local or wide area network.

Computer 102 is designated as a remote host which runs applications software that is accessible from any of local terminals 103 to 105, which may be implemented as PCs programmed to emulate “dumb” terminals.

U.S. Pat. Nos. 5,792,659 and 5,812,127, assigned to the same assignee as the present patent application, disclosed various techniques for recognizing the particular screen downloaded at the PC, utilizing a screen identification (“ID”) code. As the screens are recognized, they may be displayed to the user in various formats and with various defined attributes.

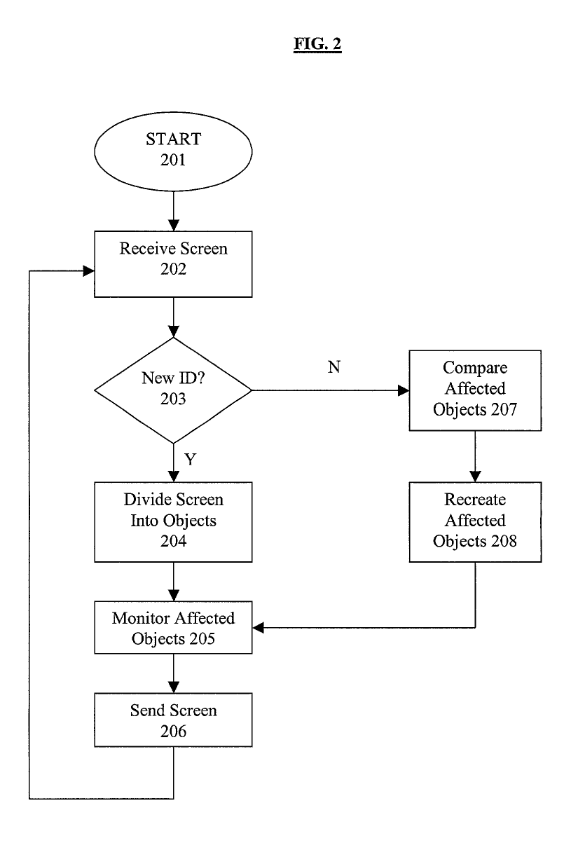

FIG. 2 shows a flow chart of the novel method of the present invention, which can be implemented in any of a variety of programming languages to update the screens at the local terminal.

Specifically, as the program enters start 201, a screen of information is transmitted from the host computer to the local terminal at operational block 202. The program recognizes, at decision block 203, the screen (i.e., it recognizes whether the screen has a different layout or different fields, etc. from the previous screen) by using identification methods, such as those described in the commonly owned '659 or '127 patents referenced above. If it is a new image having a new screen ID, the program divides the screen into objects at operational block 204.

It is noted that the division of the screens into objects may be based on the input fields, as described in this embodiment, or on other division methods as would be obvious to those of ordinary skill in the art. For example, each object could comprise a character position, or blocks of characters. Alternatively, the entire screen could be divided into an appropriate grid, where each square in the grid comprises an object. Any number of screen division techniques known in the art could be used at block 204, as long as they suitably minimize the screen area needed to be compared and regenerated.

Continuing with reference to FIG. 2, upon data entry by the user, the program monitors, at block 205, which objects are affected by the new entry. It is understood that the invention is meant to cover various possible types of user input, such as characters or function keys.

The local computer then transmits the new data information to the host computer at block 206. Returning in the flow chart to block 202, the host computer processes the information and downloads updated screen information to the local computer. Upon receiving the updated screens at the local terminal, the terminal emulator program recognizes the screen at block 203. It then compares only the changed objects, rather than the entire screen, in the new and old screens at operational block 207. The program then repaints only the changed objects in the PC display at block 208, thereby reducing the amount of processing power required to compare and repaint the screens.

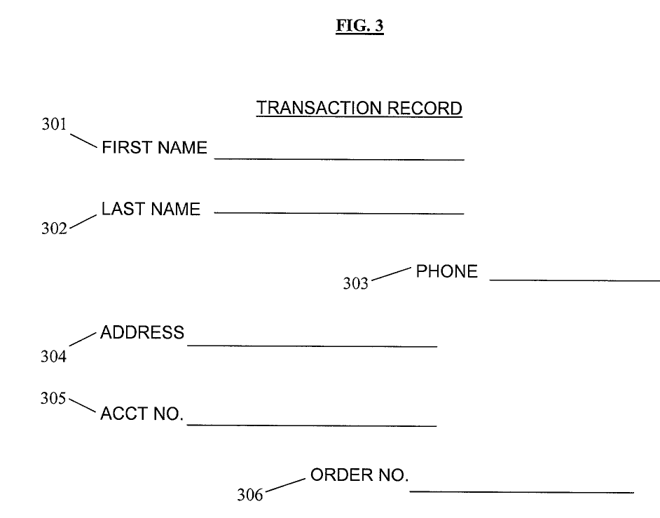

FIG. 3 shows an example screen for a particular type of data record to be entered. The exemplary screen of FIG. 3 is entitled “Transaction Record” and includes 5 fields of data as shown. For example, fields 301 and 302 are indicated as “first name” and “last name”. The drawing of FIG. 3 is intended to represent the actual display of the screen after it is recognized by the local terminal emulator and displayed on the PC, as previously described therein.

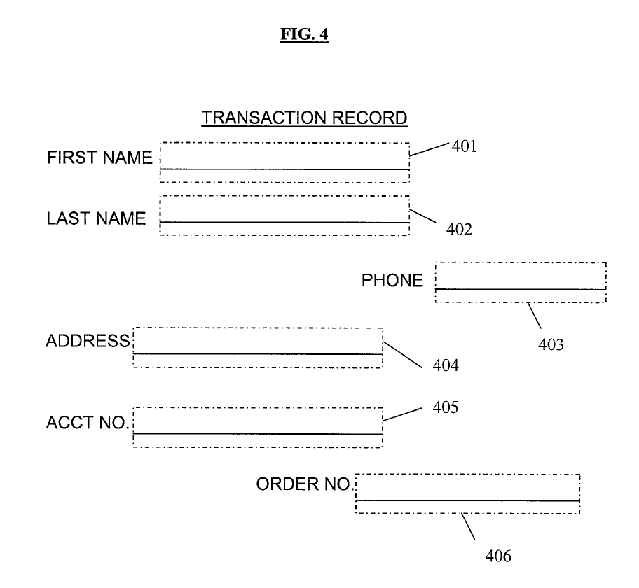

FIG. 4 shows the same screen as shown in FIG. 3, with blocks 401-406 comprising the above described objects into which the screen is divided. Each object comprises a data field, which may change upon data input by the user. The program monitors which objects are affected by data input. It then only needs to compare and recreate those affected objects for display, rather than the entire screen.

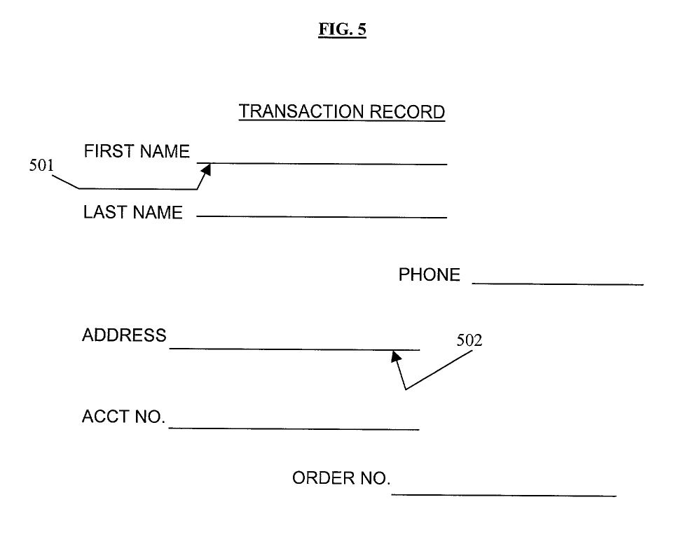

FIG. 5 depicts an example of a cursor movement in connection with a GUI, utilizing another novel method of the present invention. The user uses a mouse to move the cursor from position 501 in one field to position 502 within another field.

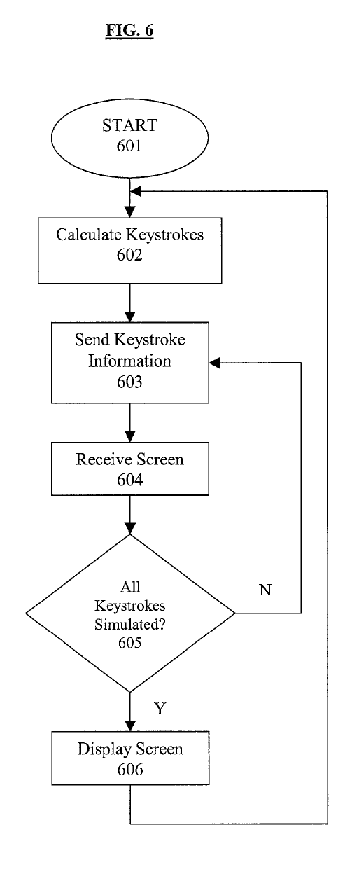

FIG. 6 shows the steps required for the terminal emulator to accomplish such cursor movement, in accordance with the present invention. Specifically, as the program enters start 601, upon receiving a cursor movement signal, the program calculates, at operational block 602, the optimum keystrokes or keystroke combination to use, to cause the necessary movement on the screen. As an example, the program may calculate the combination that requires the minimum number of keyboard strokes, thereby minimizing the data processing and transmissions of information required.

In the screen layout of FIG. 5, the optimum keystrokes to move from points 501 to 502 includes 4 tab strokes to move from the first position in the “first name” field to the first position in the “acct no.” field. Assuming that the “address” field has a total length of 40 character positions, it would then require only 5 backspace strokes to reach point 502 in the “address” field. This keystroke combination results in a total number of 9 “steps” to move the cursor from point 501 to point 502.

Conventional techniques for accomplishing this same movement might require 4 tab strokes to reach the first position in the “address” field. It may then use 34 forward space strokes to reach point 502, resulting in a total of 38 steps. In the above described preferred embodiment, the program utilizes a maximum number of large “steps” (e.g., tabs) and a minimum number of small “steps” (e.g., backspaces). Conventional techniques do not encompass this concept of optimizing the steps to use.

Returning to FIG. 6, the program sends the first keystroke information to the host computer at block 603, which then downloads updated screen information to the local PC at block 604. If at decision block 605 there are remaining keystrokes to be executed, control is returned to block 603, where the next keystroke information is sent to the host computer. Updated screen information is again received by the local terminal at bock 604, and the loop continues until all of the calculated keystrokes have been executed.

Blocks 602-605 comprise a method to simulate keystrokes and is, of course, transparent to the user. If at block 605 it is determined that the final keystroke has been simulated, the desired screen has been received at the local computer. The terminal emulator then displays that screen at block 605, showing the desired cursor movement to the user.

It is anticipated by the invention that various parameters for optimizing the simulated keystrokes may be defined. In other possible embodiments, various combinations of simulated keyboard movements and keycodes can be utilized in this technique. For example, the method may encompass combinations of control and escape keycodes.

While the above describes the preferred embodiments of the invention, it will be apparent to those of ordinary skill in the art that numerous modifications and/or additions may be implemented. Such modification and variations are intended to be covered by the following claims.

What is claimed is:

1. In a system comprising a remote computer and a plurality of user terminals, a method of updating the display at a user terminal comprising the steps of:
receiving a screen of information transmitted from the remote computer at the user terminal;
dividing the screen into a plurality of objects;
detecting which of the objects are affected by input by a user;
sending information regarding the user input to the remote computer;
receiving new screen information at the user terminal; and
comparing only the changed objects in the new screen and the old screen.

2. The method of claim 1, wherein said objects comprise fields into which data is to be entered by a user.

3. The method of claim 1, wherein said objects comprise character positions into which data is to be entered by a user.

4. In a system comprising a remote computer and a plurality of user terminals, a method of updating the display at a user terminal comprising the steps of:
receiving a screen of information transmitted from the remote computer at the user terminal;
dividing the screen into a plurality of objects;
detecting which of the objects are affected by input by a user;
sending information regarding the user input to the remote computer;
receiving new screen information at the user terminal;
comparing only the changed objects in the new screen and the old screen; and
recreating only the changed objects in the user display.

5. The method of claim 4, wherein said objects comprise fields into which data is to be entered by a user.

6. The method of claim 4, wherein said objects comprise character positions into which data is to be entered by a user.

7. In a system comprising a remote computer and a plurality of user terminals, a method of moving a cursor, in response to signals from an input device, comprising the steps of:
calculating which keystrokes or combination of keystrokes to use;
sending the keystroke information to the remote computer;
receiving new screen information at the user terminal; and
displaying the cursor movement at the user terminal.

8. The method of claim 1 wherein said calculation of keystrokes comprises maximizing the number of larger keystrokes to use, and minimizing the number of smaller keystrokes to use.

9. The method of claim 1 wherein said calculation of keystrokes comprises minimizing the number of keystrokes to use.

10. The method of claim 2 wherein said larger keystrokes to use include tab keystrokes.

11. The method of claim 2 wherein said smaller keystrokes to use include backspace keystrokes.
